(19) United States
(12) Patent Application Publication
(10) Pub. No.: US 2015/0244938 A1
(43) Pub. Date: Aug. 27, 2015

(54) TECHNIQUES FOR ELECTRONICALLY ADJUSTING VIDEO RECORDING ORIENTATION

(71) Applicants: STELIOS PETRAKIS, THESSALONIKI (GR); PETROS DOUVANTZIS, THESSALONIKI (GR)

(72) Inventors: STELIOS PETRAKIS, THESSALONIKI (GR); PETROS DOUVANTZIS, THESSALONIKI (GR)

(21) Appl. No.: 14/188,714

(22) Filed: Feb. 25, 2014

(51) Int. Cl. H04N 5/232; H04N 5/77; H04N 5/14; H04N 5/91

(52) U.S. Cl. CPC H04N 5/23258; H04N 5/91; H04N 5/772; H04N 5/145

(57) ABSTRACT

Techniques are described for electronically adjusting video recording orientation. A video recording device including a motion sensor measures the rotational angle and adjusts the video orientation so that the resultant video is fixed. The original video frame and adjusted video frame are shown simultaneously for ease of use. Scaling of the adjusted video frame is performed to maximize the resolution and preserve as much detail as possible in the recorded video. In an alternate mode of operation, video output is set to a fixed scale.

### TECHNICAL FIELD

The present disclosure relates video capture on electronic devices video, and more particularly, to techniques for adjusting an electronic video recording.

### BACKGROUND

Electronic devices, including portable electronic devices, have gained widespread use and may provide a variety of functions including, for example, live video capturing and recording. Portable devices include digital cameras, cellular telephones, smart phones, wireless personal digital assistants (PDAs), and laptop computers.

Portable electronic devices such as PDAs or smart telephones are generally intended for handheld use and ease of portability. The inclusion of video capturing and recording capability in portable electronic is particularly useful and convenient. It is important to users of these electronic devices to capture the best quality and aesthetically pleasing video as possible.

Improvements in electronic devices with video capturing and recording capability are desirable.

### SUMMARY

The present disclosure describes techniques for electronically adjusting video recording orientation. A video recording device including a motion sensor measures the rotational angle and adjusts the video orientation so that the resultant video is fixed. The original video frame and adjusted video frame are shown simultaneously for ease of use. Scaling of the adjusted video frame is performed to maximize the resolution and preserve as much detail as possible in the recorded video. In an alternate embodiment, video output can also be set to a fixed scale.

The summary is neither intended nor should it be construed as being representative of the full extent and scope of the present disclosure, which these and additional aspects will become more readily apparent from the detailed description, particularly when taken together with the appended drawings.

### BRIEF DESCRIPTION OF THE DRAWINGS

FIG. 1 shows a block diagram of a video recording device for an embodiment of the present invention.

FIG. 2 shows a free space spatial orientation of the video recording device.

FIG. 3 shows an example web based screen demonstration of the HORIZON application.

FIG. 4 shows captured vertical video displayed on a widescreen monitor.

FIG. 5 shows a web screen from the Apple™ App Store of the HORIZON application including UI screen examples.

FIG. 6 is a high level operational flow diagram of a routine running on a processor in a video recording device, in accordance with a preferred embodiment.

FIG. 7 is a further high level operational flow diagram of a routine running on a processor in a video recording device for detecting a change in rotational angle during video frame capture, in accordance with the present invention.

FIG. 8 is a high level operational flow diagram of a routine running on a processor in a video recording device, in accordance with an alternate embodiment.

FIG. 9 shows an example of adjusting captured video frames in two different modes of operation.

### DETAILED DESCRIPTION

The detailed description set forth below in connection with the appended drawings is intended as a description of exemplary embodiments of the present invention and is not intended to represent the only embodiments in which the present invention can be practiced. The term “exemplary” used throughout this description means “serving as an example, instance, or illustration,” and should not necessarily be construed as preferred or advantageous over other exemplary embodiments. The detailed description includes specific details for the purpose of providing a thorough understanding of the exemplary embodiments of the invention. It will be apparent to those skilled in the art that the exemplary embodiments of the invention may be practiced without these specific details. In some instances, well-known structures and devices are shown in block diagram form in order to avoid obscuring the novelty of the exemplary embodiments presented herein.

The techniques described herein may be used in any device that captures a video recording from an electronic camera module. A video frame can be captured with a plurality of frame rates and with a plurality of formats, as is known in the art. Linear transformations of video frames, including scaling, rotation, and interpolation are also well known in the art.

The present disclosure describes techniques for electronically adjusting video recording orientation. An electronic device with a camera module and a motion sensor. Portable phones, smart phones, and PDAs are being used more and more to capture video. With the advent of high speed wireless technologies such as, but not limited to, 4G LTE and WiFi. It has also become very convenient to capture video and share the video via social media sites. Real time video chat use is increasing as well. There appears to also be a large increase in video capture and sharing that is ultimately used by law enforcement officers and in criminal proceedings where a crime was captured on a portable video device. Often this video is not of high quality due to excessive movement by the operator even though many devices employ image stabilization techniques (this topic is further addressed below).

The idea of image stabilization is generally known. When a video recording device is used, there can be movement of the device due to camera shake. The result is recorded video that is difficult to track and is aesthetically displeasing. Camera shake also becomes magnified when the video recording device employs large focal length lenses, as the longer focal length tends to amplify a small shake movement, further degrading the aesthetics of the captured video. Some image stabilization techniques are implemented via mechanical means. Generally there are electric motors that compensate for the small change in device position, as during a shake event, to dampen the shake movement and ultimately render a stable recording. The motion picture industry employs many of these mechanical image stabilization mechanisms. The other type of image stabilization is through electronic manipulation of images. Digital cameras, smart phones, cellular phones with cameras, as well as PDAs generally use electronic manipulation for image stabilization. In electronic image stabilization, one or more frames is generally compared along with motion sensor data and the video recording is adjusted to reduce camera shake. In many digital cameras, a hybrid approach is used, wherein electronic motors manipulate lens elements in the camera while simultaneously adjusting the video frames electronically.

In all video stabilization techniques, the goal is to provide video that has little or no camera shake. The present invention is not an image stabilization technique, rather, the present invention is to adjust the video perspective along only one axis. Image stabilization is used to counter unintentional three dimensional physical inputs of the recording device, usually of relatively small amplitude and high frequency. In the case of the HORIZON app, the device processor is configured to adjust captured video frames to fix the rotational yaw axis to a fixed angle (for example, 0 degrees of yaw with respect to the horizon).

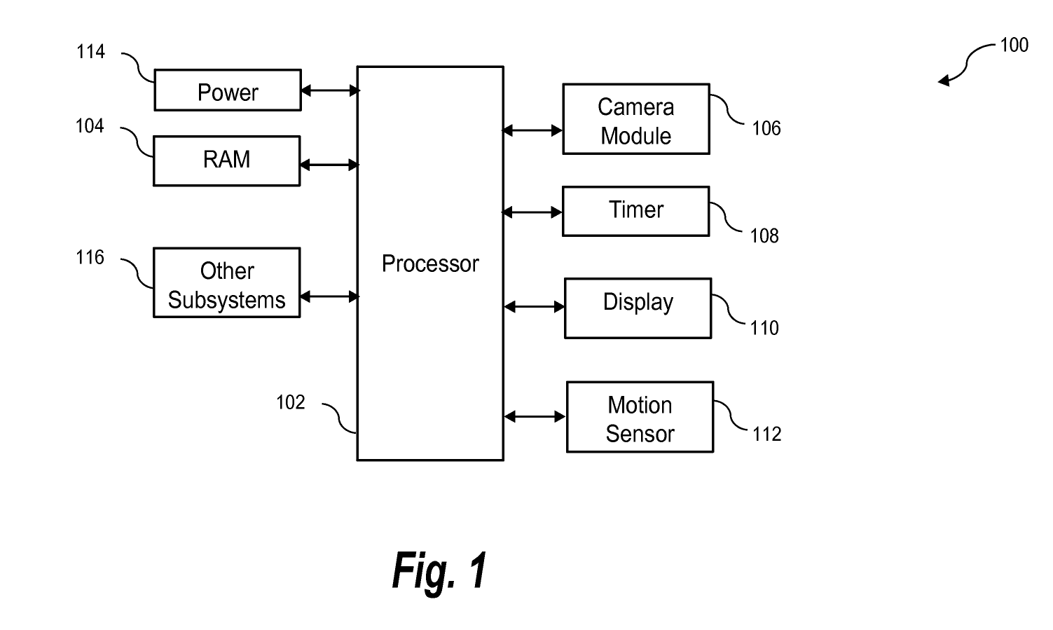

FIG. 1 shows a block diagram of video recording device 100 for an embodiment of the present invention. Those skilled in the art would appreciate that only those functional parts of video recording device 100 are depicted to facilitate the description of the present embodiment. Those skilled in the art will also understand that the present embodiment may also apply to non-wireless and non-portable devices, portable and non-portable devices, wherein there is camera module 106 configured to capture video frames.

Video recording device 100 includes multiple components, such as processor 102 that controls the overall operation of the device. Power source 114, such as one or more rechargeable batteries or a port to an external power supply, powers video recording device 100. Processor 102 may be coupled to other components, such as Random Access Memory (RAM) 104, display 110, camera module 106, timer 108, one or more motion sensors 112, and other subsystems 116. Motion sensor 112 may be at least one of an accelerometer, gyroscope, and vibration sensor. Input via a graphical user interface is provided via the display 110, wherein the display may also be touch-sensitive. Information, such as text, characters, symbols, images, icons, and other items that may be displayed or rendered on an electronic device, is displayed on the display 110 coupled to processor 102.

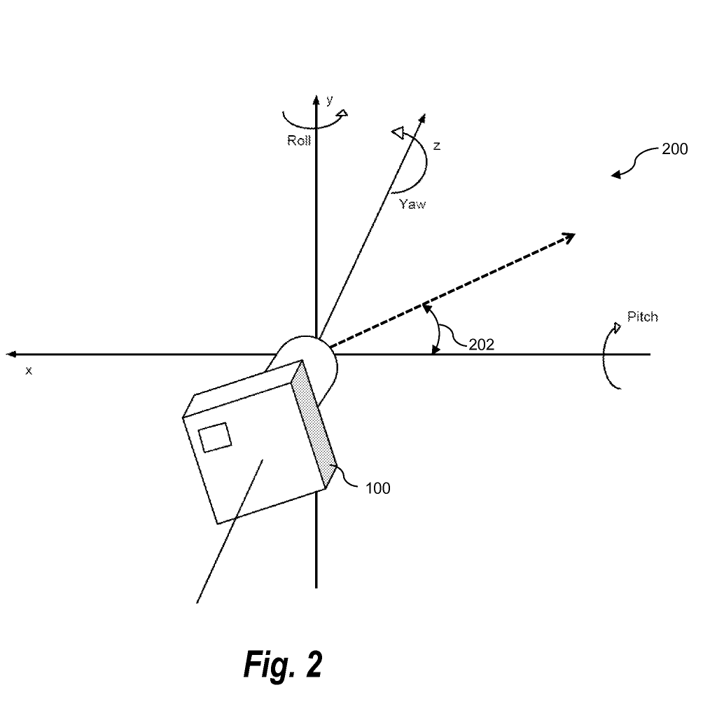

FIG. 2 shows spatial orientation 200 of video recording device 100. As is known in the art, the spatial orientation can be represented as a combination of yaw, pitch, and roll. In the present invention, yaw angle 202 is the angle relative to the horizontal. As is known in the art, gyroscopes, a type of motion sensor 112 directly output orientation values that have angular values, either in degrees or radians. In one aspect, the present invention measures the rotational angle during video frame capture and adjusts captured video frames to fit a predefined aspect ratio with respect to a single approximately fixed rational angle to facilitate video recording. The term “video frame” used in the present invention refers to an array of image pixels encompassing the entire video viewing area, as output by camera module 106.

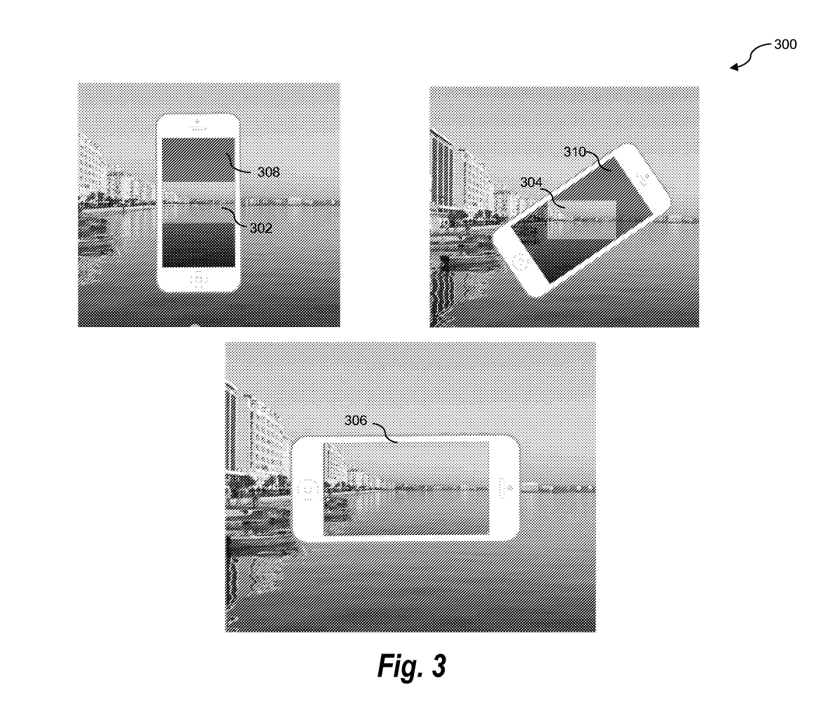

FIG. 3 shows an example web based screen demonstration of the HORIZON application. In ananother preferred embodiment aspect, the present invention simultaneously displays adjusted video frames and unadjusted video frames, wherein adjusted video portions 302, 304, and 306 are visually distinguished from unadjusted video 308 and 310. Simultaneous display of adjusted and unadjusted video may be in a side-by-side orientation instead of superimposed as depicted in FIG. 3. It should be noted when video recording device 100 is rotated with an absolute yaw angle of between 0 degrees and 90 degrees, adjusted video area 304 is smaller in area than unadjusted video 310. In another aspect, adjusted video frame 304 has been adjusted to fit with a predefined aspect ratio. In an example of adjusted video frame 304 and unadjusted video frame 310, unadjusted video frame 310 may have a pixel resolution of 1280 pixels wide by 720 pixels high while adjusted video frame 304 may have a pixel resolution less than that. In another aspect, adjusted video frame 304 may be scaled, using techniques known in the art, to achieve a pixel resolution of the original unadjusted frame 310. This adjustment may include linear interpolation, or other interpolation means. When interpolating to a higher pixel density, the net effect between adjusted and unadjusted frames to the recorded video is a zooming effect with a loss of actual detail as compared to the resolution of unadjusted video frame 310. In this case, it is advantageous to adjust adjusted video frame 304 to maximize resolution. The maximizing of adjusted video frame 304 resolution is one aspect of the preferred embodiment. When the orientation of video recording device 100 is at an essentially horizontal orientation or essentially 0 degrees yaw angle 202, adjusted video frame 306 is the same resolution as the unadjusted video frame.

Alternatively, in some video capture devices 100, camera module 106 may have natively greater resolution than the resolution of unadjusted video frame 310. It is known in the art that camera modules 106 with higher than displayed and recorded resolutions are often used to facilitate additional desirable camera features such as digital zooming. When camera module 106 has natively higher resolution than unadjusted frame 310, decimation techniques known in the art may be utilized to return the pixel resolution of adjusted video frame 304 back to the same resolution of unadjusted frame 310, without losing detail in the image and without encountering a zooming effect.

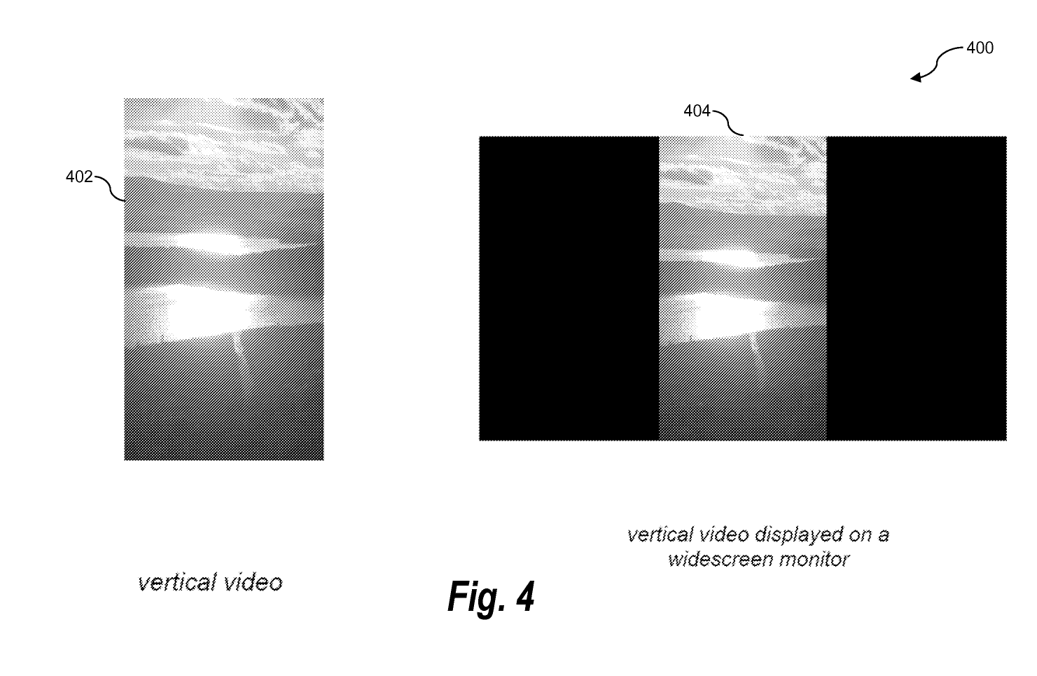

FIG. 4 shows captured vertical video displayed on a widescreen monitor. When video is recorded on video recording devices 100, and yaw angle 202 is 90 or −90 degrees, the video orientation is described in the art as vertical video. When vertical video is captured and displayed on a widescreen viewing device (e.g. television), viewing devices typically display the video with large black side bars that occupy the viewing frame. Commercially offered televisions have operating modes that will zoom in when the video is vertical to fill the viewing area so that there are no black side bars, but the resultant video is not aesthetically pleasing and large portions of the original vertical video become cut off The HORIZON app has advantages in this respect, as the user is always recording in a mode that keeps the viewing orientation horizontal.

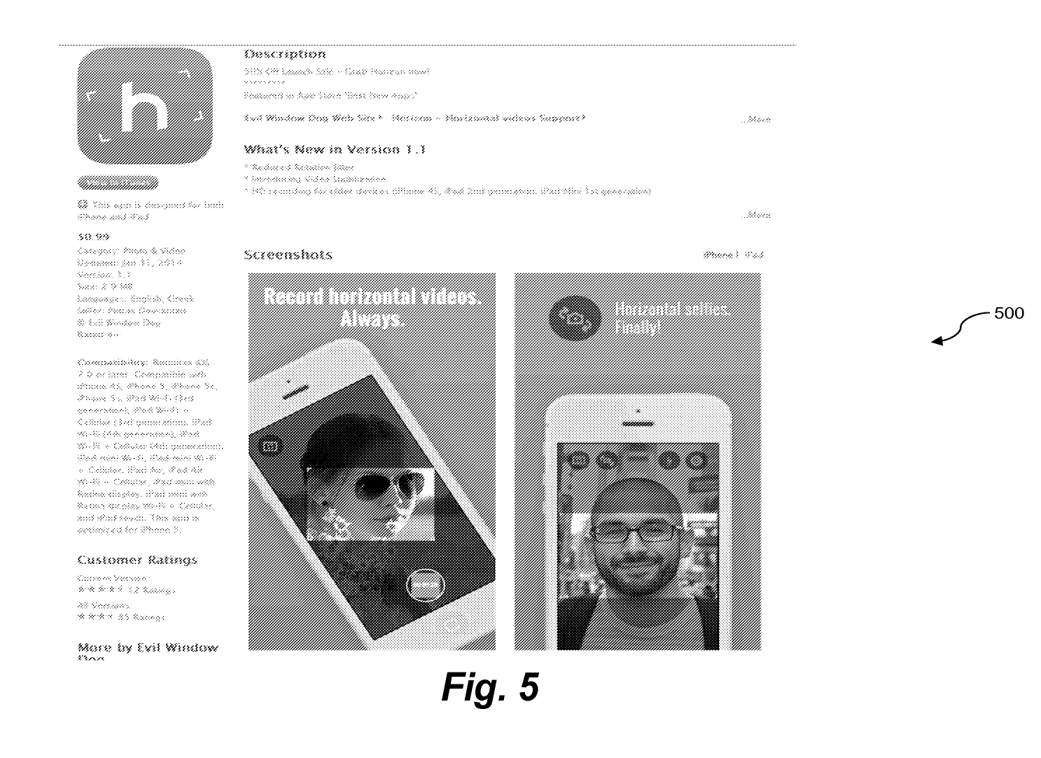

FIG. 5 shows a web screen shot from the Apple™ App Store of the HORIZON application including UI screen examples, demonstrating the value of always having horizontal video.

In accordance with the present disclosure, the following parameters and variables are defined in the table below:

| | |
|---|---|
| Aspect_Ratio | The aspect ratio of the captured video frame |
| Critical_Angle | Arctangent (Aspect_Ratio) |
| Yaw_Angle[i] | Calculated yaw angle at Time_Stamp[i] |
| Scale_Factor_1 | Scale factor calculated depending on the value of |
| | Yaw_Angle[i] |
| Scale_Factor_2 | Alternate scale factor calculated depending on the |
| | value of Yaw_Angle[i] |
| Time_Stamp[i] | The time stamp at time i, for i = 0, 1, 2, . . . |
| Scale_Factor | Scale_Factor used to scale the video frame |
| Yaw_Angle[j] | Corresponds to raw yaw angle at time_stamp[j], |
| | wherein time_stamp[j] may not coincide with |
| | time_stamp[i] |
| Scale_Factor_C | This is the critical scale factor and is equal to |
| | 1/\|cosine (arctangent (Aspect_Ratio))\| |

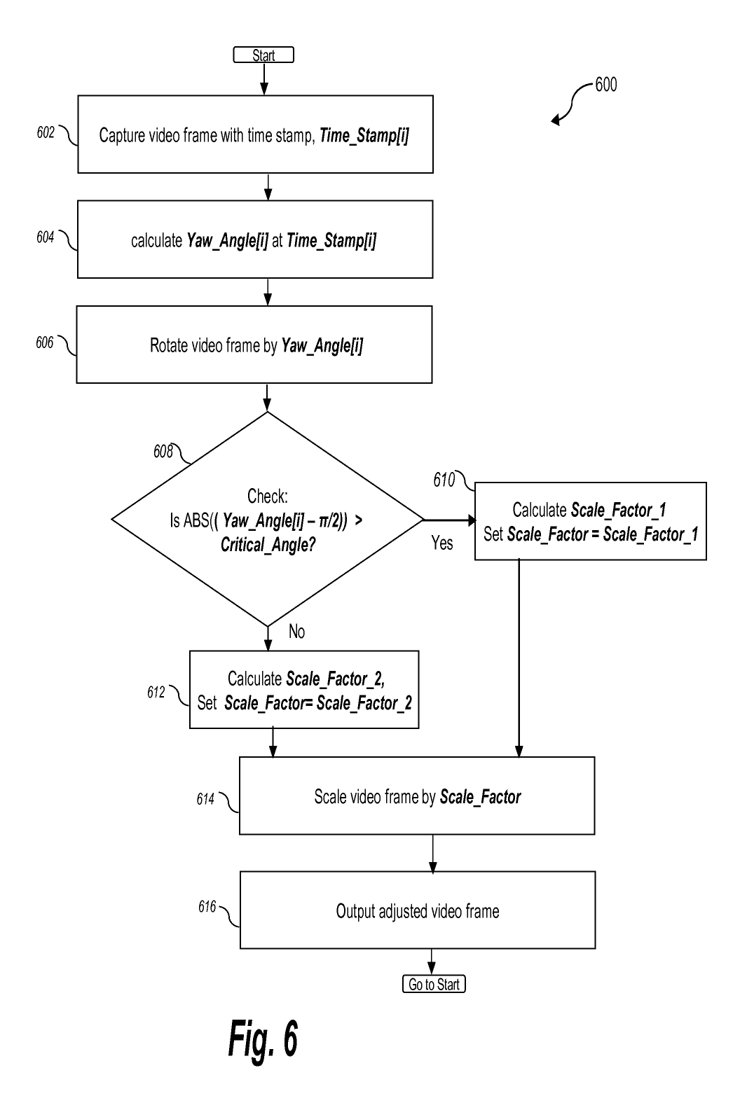

FIG. 6 is a high level operational flow diagram of a routine running on a processor in a video recording device, in accordance with a preferred embodiment. Block 602 waits for a video frame to be captured with a time stamp, Time_Stamp[i], for i=0, 1, 2, . . . . Note that Block 604 then calculates the approximate yaw angle, Yaw_Angle[i], which corresponds to the yaw angle at Time_Stamp[i] from stored values of yaw angle in RAM 104 which may correspond to time stamps that are not the same time stamps of the video frame. Video frames that are captured may already have been pre-processed through methods known in the art. These pre-processing methods may include image stabilization. Camera modules 106 typically record video in NTSC or PAL video formats, with frame rates ranging from 25-60 frames per second, with a range of resolutions and aspect ratios. Some example aspect ratios known in the art are, but not limited to, 4:3 and 16:9, with possible resolutions of 480i, 480p, 720p, 1080i, 1080p and higher. Camera modules 106 may also capture raw video at much higher resolutions than what is typically output. Motion sensors 112, in contrast, may be sampled at higher sample rates than camera modules 106. Camera modules 106 also may have an internal timing reference that is not phase locked to the timing reference of motion sensors 112 (i.e. they are asynchronous). The result of non-phase locked time references can result in time stamps that are not coincident between the time stamp of the video frames and time stamps of yaw angle data. In the case of non-phase locked time references, linear interpolation techniques known in the art are then used to approximate the yaw angle, Yaw_Angle[i], when the time stamp of the video frame and time stamps of stored yaw angles do not coincide. Block 604 then triggers block 606 which rotates the video frame an angular amount that is approximately the calculated yaw angle, Yaw_Angle[i]. This rotation allows the adjusted video frame to maintain a yaw angle of horizontal. The actual rotation transformation in block 606 uses methods well known in the art. Block 606 then triggers block 608 which checks if the absolute value of (Yaw_Angle[i]−π/2) is greater than Critical_Angle. If the check is true (i.e. “yes”) then block 608 flows to block 610. Block 610 then calculates the scale factor, Scale_Factor, to be equal to Scale_Factor_{—}1 defined by:

$$Scale\_Factor \_ 1 = \frac{1}{\vert cosine ( Yaw\_Angle [ i ] ) \vert} + \vert sine ( Yaw\_Angle [ i ] ) \vert * ( Aspect\_Ratio - \vert tan ( Yaw\_Angle [ i ] ) \vert ) ,$$

and then flows to block 614. If the check is false (i.e. “no”), then block 608 flows to block 612. Block 612 then calculates the scale factor, Scale_Factor, to be equal to Scale_Factor_{—}2 defined by:

$$Scale\_Factor \_ 2 = Aspect\_Ratio * \frac{1}{\vert sine ( Yaw\_Angle [ i ] ) \vert} + \vert cosine ( Yaw\_Angle [ i ] ) \vert * ( 1 - \vert tangent ( ( Yaw\_Angle [ i ] ) - \frac{π}{2} ) \vert * Aspect\_Ratio ) ,$$

and then flows to block 314. Block 314 scales the video frame by Scale_Factor using known methods in the art and flow continues to block 616. Block 616 outputs the rotated and scaled video frame and then returns to the start. Computing Scale_Factor on a frame by frame basis may be more computationally expensive than using a fixed value due to the need to calculate multiple trigonometric functions in processor 102 but with the tradeoff of maximizing the adjusted video output frame resolution. Furthermore, Computing Scale_Factor on a frame by frame basis may also generate a zooming effect, depending on the rotational angle of video recording device 100.

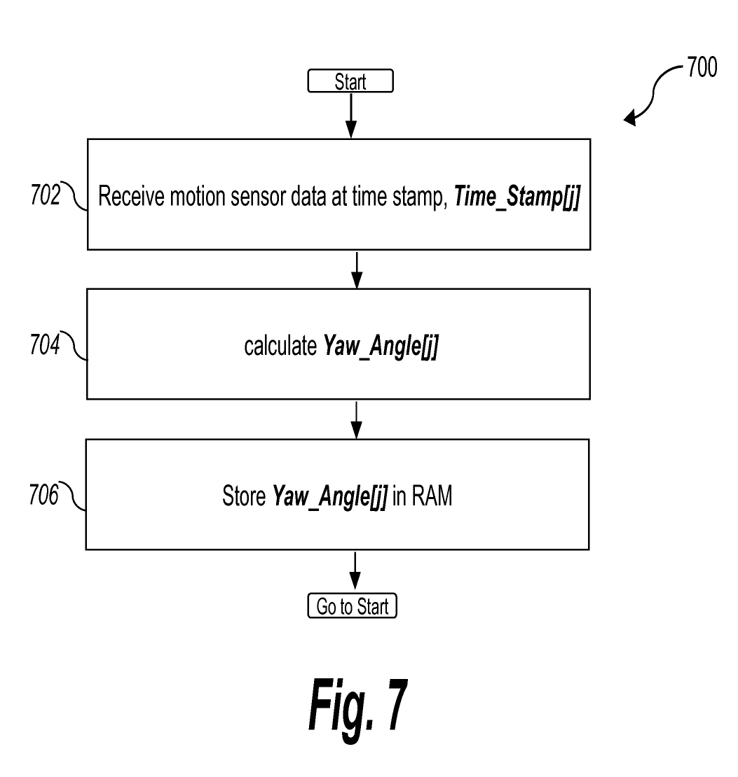

FIG. 7 is a further high level operational flow diagram of a routine running on a processor in a video recording device for detecting a change in rotational angle during video frame capture, in accordance with the present invention. Block 702 acquires raw motion sensor 112 data and triggers block 704. Block 704 then calculates yaw angle, Yaw_Angle[j], with Time_Stamp[j], for j=0,1,2, . . . from motion sensor 112. It is noted that Yaw_Angle[j] with Time_Stamp[j] may not coincide in time with Yaw_Angle[i]. In accordance with the present embodiment, a gyroscope may be used as motion sensor 112. Alternatively, calculating a yaw angle may comprise a linear combination of motion sensor 112 data corresponding to the time stamp from at least one motion sensor 112. Block 706 stores Yaw_Angle[j], with Time_Stamp[j], for j=0, 1, 2, . . . into RAM 104 and then returns. Video recording device 100 is depicted with separate components coupled to processor 102. The implementation of video recording device 100 may be substantially implemented as an application specific integrated circuit (ASIC) or as an FPGA based device. In the case of ASIC or FPGA implementation, it may be advantageous to have integrated camera module 106, timer 108, and motion sensor 112 together so that all device subsystems share common timing references and are phase locked. In this aspect, the linear combination of motion sensor 112 data from at least one motion sensor may be synchronous.

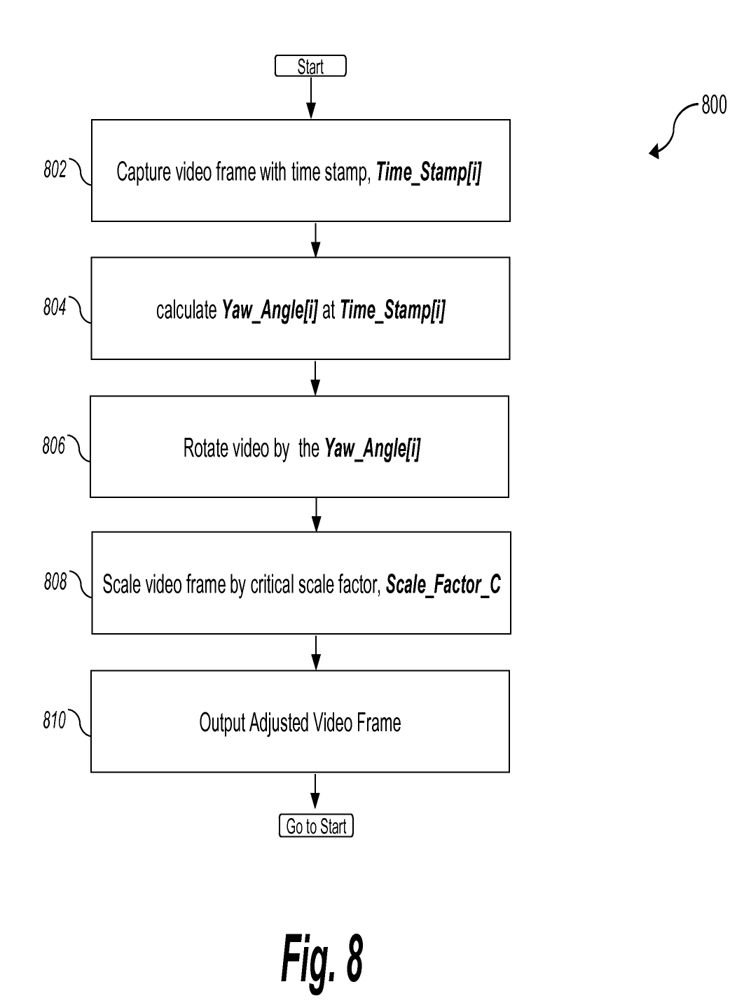

FIG. 8 is a high level operational flow diagram of a routine running on a processor in a video recording device, in accordance with an alternate embodiment. In one aspect, the alternate embodiment Block 802 waits for an incoming video frame to be captured with at time stamp, Time_Stamp[i], for i=0, 1, 2, . . . . All latitudes with respect to pre-processing of incoming video frames using image stabilization are still valid for the alternate embodiment. A potential advantage of the alternate embodiment is the scaling is fixed and, as such, does not exhibit a continuously variable zooming effect. A disadvantage of the alternate embodiment may be that the adjusted frames have lower output resolution. However, as mentioned above, a device that has camera module 106 with sufficiently high resolution, can maintain the original frame resolution and aspect ratio without loss of detail. The Horizon app allows mode selection between the preferred and alternate embodiments of the present invention.

Block 804 then calculates the approximate yaw angle, Yaw_Angle[i], which corresponds to the yaw angle at Time_Stamp[i] from stored values of yaw angle in RAM 108 which may correspond to time stamps that are not the same time stamps of the video frame data. Linear interpolation techniques known in the art are then used to approximate the yaw angle, Yaw_Angle[i], when the time stamp of the video frame and time stamps of stored yaw angles do not coincide (in the asynchronous case). Block 804 then triggers block 806 which rotates the video frame an angular amount that is approximately the calculated yaw angle, Yaw_Angle[i]. The rotation in block 806 uses methods well known in the art. Block 808 then scales the video frame by 1/|cosine ( arctangent (Aspect_Ratio))|, defined in the table above as Scale_Factor_C, using known scaling methods in the art. Flow then continues to block 810. Block 810 outputs the adjusted video frame and then returns to the start.

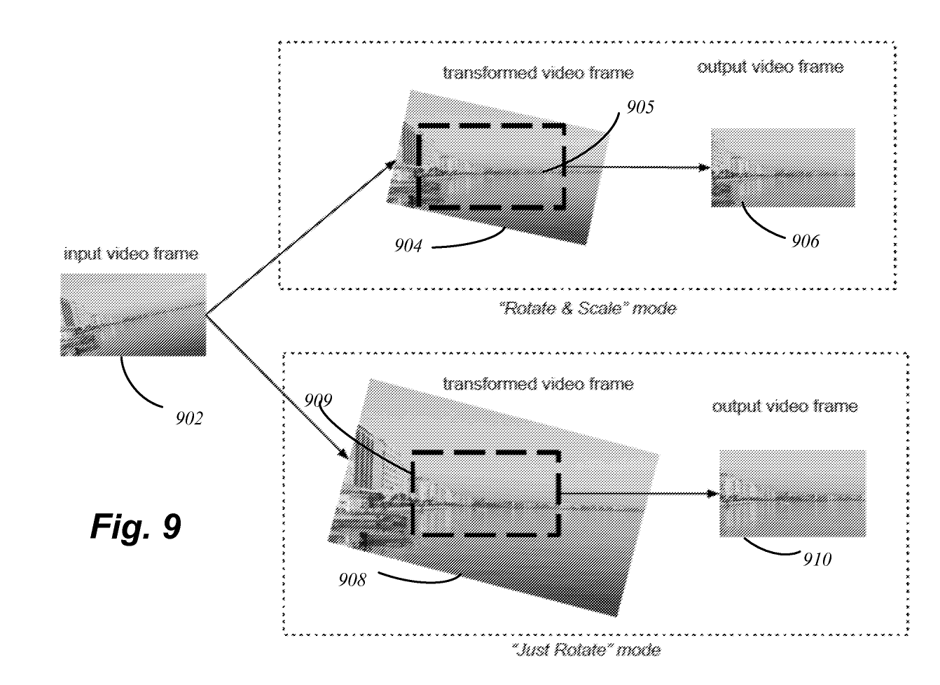

FIG. 9 shows an example of adjusting captured video frames in two different modes of operation. A commercial example of the present invention with both embodiments implemented is the HORIZON application available at the Apple™ App Store. Input video frame 902 is shown with an apparent yaw orientation that is skewed from the horizontal axis and the adjustment made based on user selected mode of operation.

In a first mode of operation (shown as “Rotate & Scale” mode), adjusted video frame 905, 906 is shown scaled so as to maximize output resolution. In a second mode of operation (shown as “Just Rotate” mode), adjusted video frame 909, 910 of the alternate embodiment employs fixed scaling and is characterized by possible lower average resolution as compared to the first mode of operation. The HORIZON application implements both embodiments and allows the selection as to which embodiment to record video with.

Those of skill in the art would understand that signals may be represented using any of a variety of different techniques. For example, data, instructions, signals that may be referenced throughout the above description may be represented by voltages, currents, electromagnetic waves, magnetic fields or particles, or any combination thereof.

Those of skill would further appreciate that the various illustrative blocks described in connection with the disclosure herein may be implemented in a variety of different circuit topologies, on one or more integrated circuits, separate from or in combination with logic circuits and systems while performing the same functions described in the present disclosure.

Those of skill would also further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), a graphics processor (GPU), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a GPU core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor may read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal

The previous description of the disclosure is provided to enable any person skilled in the art to make or use the disclosure. Various modifications to the disclosure will be readily apparent to those skilled in the art, and the generic principles defined herein may be applied to other variations without departing from the scope of the disclosure. Thus, the disclosure is not intended to be limited to the examples and designs described herein but are to be accorded the widest scope consistent with the principles and novel features disclosed herein.

What is claimed is:

1. In a video recording device including a motion sensor configured to detect rotational angle, a method comprising:
measuring a rotational angle during video frame capture; and
adjusting captured video frames to fit a predefined aspect ratio with respect to a single approximately fixed rotational angle to facilitate video recording.

2. The method of claim 1,
wherein the adjusted video frames and unadjusted video frames are simultaneously displayed on a display; and
wherein the unadjusted video portion of the video frame is visually distinguished from the adjusted video portion of the video frame.

3. The method of claim 1, wherein the measuring a rotational angle during video frame capture is calculated using a yaw angle.

4. The method of claim 3, wherein the yaw angle calculation comprises a linear combination of motion sensor data from at least one motion sensor.

5. The method of claim 4, wherein the linear combination of motion sensor data from at least one motion sensor is synchronous.

6. The method of claim 1, wherein the adjusting captured video frames is adjusted to maximize the output resolution.

7. The method of claim 1, wherein the adjusting captured video fixes the magnitude portion of the adjustment to a value approximately equal to 1/|cosine ( arctangent (aspect ratio))|.

8. A video recording device including a motion sensor comprising:
means for measuring a rotational angle during video frame capture; and
means for adjusting captured video frames to fit a predefined aspect ratio with respect to a single approximately fixed rotational angle to facilitate video recording.

9. The device of claim 8,
wherein adjusted video frames and unadjusted video frames are simultaneously displayed on a display; and
wherein the unadjusted video portion of the video frame is visually distinguished from the adjusted video portion of the video frame.

10. A portable handheld device including a motion sensor comprising:
a processor; and
a camera module coupled to the processor and configured to:
measure a rotational angle during video frame capture; and
adjust captured video frames to fit a predefined aspect ratio with respect to a single approximately fixed rotational angle to facilitate video recording.

11. The portable handheld device of claim 10,
wherein adjusted and unadjusted video frames are simultaneously displayed on a display; and
wherein the unadjusted video portion of the video frame is visually distinguished from the adjusted video portion of the video frame.

12. The portable handheld device of claim 10, wherein the measure a rotational angle during video frame capture is calculated using a yaw angle.

13. The portable handheld device of claim 12, wherein the yaw angle calculation comprises a linear combination of motion sensor data from at least one motion sensor.

14. The portable handheld device of claim 13, wherein the linear combination of motion sensor data from at least one motion sensor is synchronous.

15. A computer-readable device having computer-readable code executable by at least one processor of the video recording device to perform the method comprising:
measuring a rotational angle during video frame capture; and
adjusting captured video frames to fit a predefined aspect ratio with respect to a single approximately fixed rotational angle to facilitate video recording.

16. The computer-readable device of claim 15,
wherein the adjusted video frames and unadjusted captured video frames are simultaneously displayed on a display; and
wherein the unadjusted video portion of the video frame is visually distinguished from the adjusted video portion of the video frame.
